(19) United States
(12) Patent Application Publication
(10) Pub. No.: US 2009/0239594 A1
(43) Pub. Date: Sep. 24, 2009

(54) COMMUNICATION DEVICE

(75) Inventors: JIN HUANG, Shenzhen City (CN); CHU-YUN DUAN, Shenzhen City (CN); BIN CHEN, Shenzhen City (CN); LI XIAO, Shenzhen City (CN); YAN WEI, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/168,903

(22) Filed: Jul. 8, 2008

(30) Foreign Application Priority Data
Mar. 21, 2008 (CN) 200810300656.X

(51) Int. Cl. H04B 1/38

(52) U.S. Cl. 455/575.1

(57) ABSTRACT

A communication device includes a first housing and a second housing. The first housing is provided with a plurality of keys. The first housing defines at least one guiding groove in a top surface of the first housing. The second housing is provided with at least one sliding member. The at least one sliding member is slidably fitted in at least one guiding groove for guiding the second housing to slide relative to the first housing. The second housing substantially covers all the top surface of the first housing in a first position. The second housing partially covers the plurality of keys in a second position. The second housing inclines at an angle with respect to the first housing in a third position.

### BACKGROUND

1. Field of the Invention

The present invention generally relates to communication devices, and particularly to a communication device such as a mobile phone having a multi-position opening mechanism.

2. Description of related art

In general, mobile phones are classified into bar type phones, flip/fold type phones, and sliding type phones according to their structures.

The bar type phones are designed to integrate input units and output units in a single housing. The flip/fold type phones are designed to allow a cover to pivot relative to a body via a hinge module. Comparing with the flip/fold type phones, the sliding type phones operate by sliding a first housing relative to a second housing so as to open or close the phones.

However, regarding to the aforesaid three type of mobile phones, no opening mechanism is provided for the bar type phones, only one pivotable direction movement is provided in most flip/fold type phones, and only one sliding direction movement is provided for the sliding type phones. This one directional movement provides a limited degree of freedom for manipulating of the phones.

Therefore, it is desired to provide a communication device having a multi-position opening mechanism for facilitating users to open and close the communication device.

### SUMMARY

Accordingly, a communication device having a multi-position opening mechanism for facilitating users to open and close the communication device is provided. The communication device includes a first housing and a second housing. The first housing is provided with a plurality of keys for inputting commands to the communication device. The first housing defines at least one guiding groove in a top surface of the first housing. The second housing is slidably and pivotably coupled to the first housing. The second housing is provided with at least one sliding member corresponding to the at least one guiding groove. The at least one sliding member is slidably fitted in at least one guiding groove for guiding the second housing to slide relative to the first housing sequentially from a first position, to a second position, and a third position. The second housing substantially covers all the top surface of the first housing in the first position. The second housing covers a part of the plurality of keys in the second position. The second housing inclines at an angle with respect to the first housing. Substantially all the plurality of keys is exposed to be viewable on the top surface of the first housing in the third position.

Other advantages and novel features will become more apparent from the following detailed description of exemplary embodiment when taken in conjunction with the accompanying drawings.

### BRIEF DESCRIPTION OF THE DRAWINGS

FIG. 1 is a first view of a communication device in a first position in accordance with a first exemplary embodiment.

FIG. 2 is a sectional view of the communication device taken along a line II-II shown in FIG. 1.

FIG. 3 is a sectional view of the communication device taken along a line III-III shown in FIG. 1.

FIG. 4 is a first view of a communication device in a second position in accordance with the first exemplary embodiment.

FIG. 5 is a sectional view of the communication device taken along a line V-V shown in FIG. 4.

FIG. 6 is a first view of a communication device in a third position in accordance with the first exemplary embodiment.

FIG. 7 is a sectional view of the communication device taken along a line VII-VII shown in FIG. 6.

FIG. 8 is a first view of a communication device in a third position in accordance with a second exemplary embodiment.

FIG. 9 is a sectional view of the communication device taken along a line IX-IX shown in FIG. 8.

FIG. 10 is a first view of a communication device in a first position in accordance with a third exemplary embodiment.

FIG. 11 is a sectional view of the communication device taken along a line XI-XI shown in FIG. 10.

FIG. 12 is a sectional view of the communication device shown in FIG. 10.

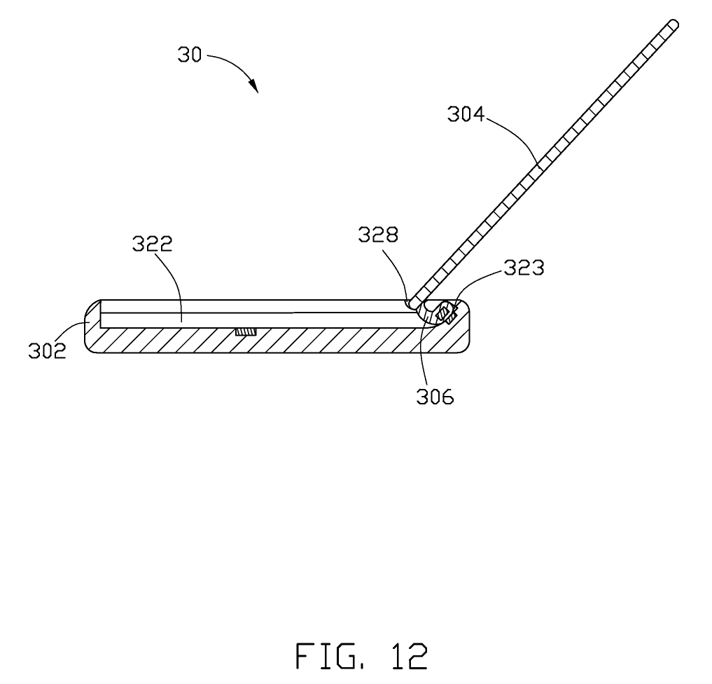

### DETAILED DESCRIPTION

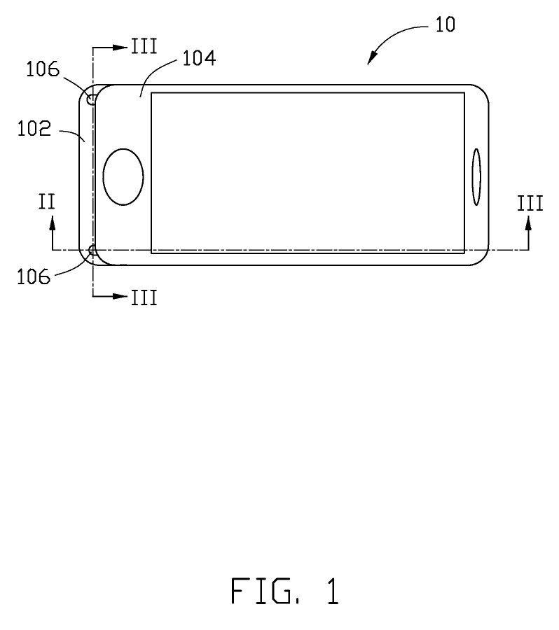

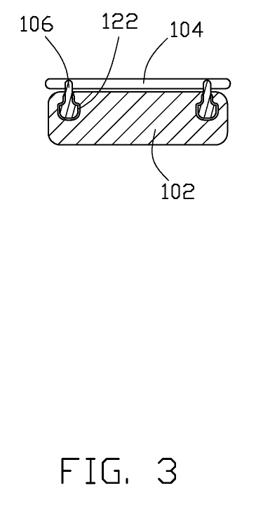

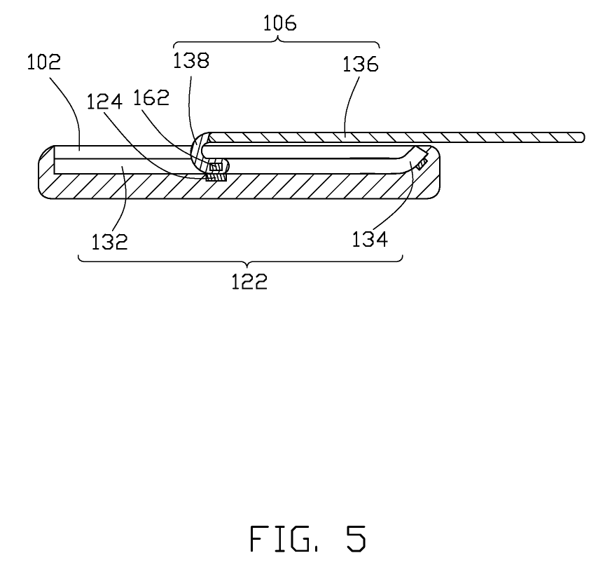

Referring to FIGS. 1-7, a first communication device 10, such as a mobile phone, in accordance with a first exemplary embodiment is illustrated. The first communication device 10 includes a first housing 102 and a second housing 104. The first housing 102 and the second housing 104 are configured to have substantially the same lengths and widths. The second housing 104 is configured to be moveable relative to the first housing 102 sequentially from a first position, to a second position, and to a third position and vice versa. In each of the three positions, the first communication device 10 may be configured to perform different functions correspondingly.

For example, in the first position, as shown in FIG. 1, the first housing 102 substantially covers a top surface of the second housing 104. In the first position, the first communication device may be used for reproducing audible sounds.

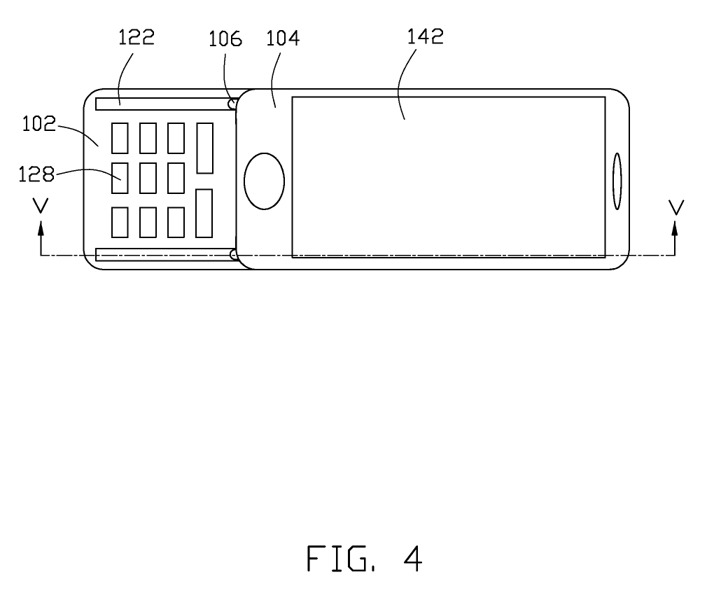

In the second position, as shown in FIG. 4, the second housing 104 partially covers the top surface of the first housing 102. In the second position, the first communication device 10 is capable of making phone calls and sending short messages.

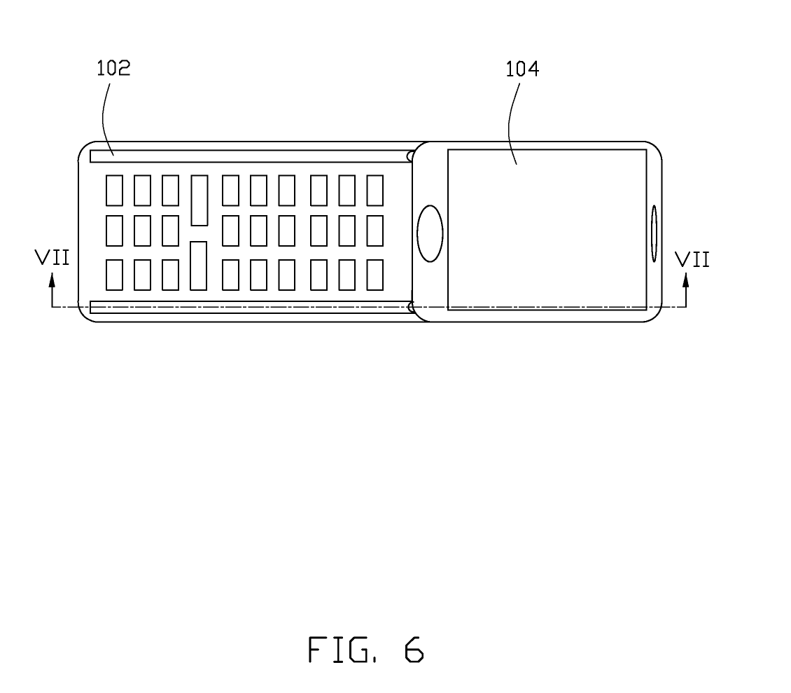

In the third position, as shown in FIG. 6, the second housing 104 is pivoted to a predetermined angle with respect to the first housing 102. The second housing 104 is substantially fully opened with respect to the first housing 102. In this third position, the first communication device 10 is capable of extended functionality such as game playing or the display can act as a video output when the device is placed on a table or other flat surface.

Hereinafter, a detail structure of the first communication device 10 will be described.

The first housing 102 includes input units, such as a plurality of keys 128. The plurality of keys 128 is provided on the top surface of the first housing 102. The plurality of keys 128 is arranged for inputting commands to the first communication device 10. The first housing 102 is substantially rectangular and further defines a pair of guiding grooves 122 adjacent to the longer sides of the top surface of the first housing 102 correspondingly.

The pair of guiding grooves 122 are formed parallel to each other for receiving a pair of sliding members 106 disposed in the second housing 104 correspondingly. Each of the guiding grooves 122 is formed by a straight groove 132 and a curved groove 134 communicating with each other. The straight grooves 132 extend parallel along the longer sides of the first housing 102 correspondingly for guiding a sliding movement of the second housing 104 relative to the first housing 102. The curved grooves 134 communicate with the straight grooves 132 correspondingly, and extend in a direction towards the top surface and slant away from the first housing 132. The curved groove 134 is configured for guiding the second housing 104 to pivotally rotate to a predetermined angle relative to the first housing 102.

The first housing 102 further includes a first magnetic member 124 and a second magnetic member 126. The first magnetic member 124 is disposed generally in or adjacent to a central portion of the straight groove 132. The first magnetic member 124 is configured for facilitating the second housing 104 to move from the first position to the second position and preventing the second housing 104 from sliding pass the second position when moving from the first position. The second magnetic member 126 is disposed in the curved groove 134 for facilitating the second housing 104 to move relative to the first housing 102 from the second position to the third position, and preventing the second housing 104 from returning to the second position from the third position.

The second housing 104 is provided with the pair of sliding members 106 at a bottom surface of the second housing 104. The pair of the sliding members 106 is configured for facilitating the multi-position movement of the second housing 104 relative to the first housing 102. Each of the sliding members 106 is generally hook-shaped and formed by a planar plate 136 and a bent portion 138. The planar plate 136 of each of the sliding members 106 is mounted to the bottom surface of the second housing 104 correspondingly. The bent portion 138 of each of the sliding members 106 is connected to an end of the planar plate 136. The bent portions 138 fittingly engage with the guiding groove 122 of the first housing 102 correspondingly.

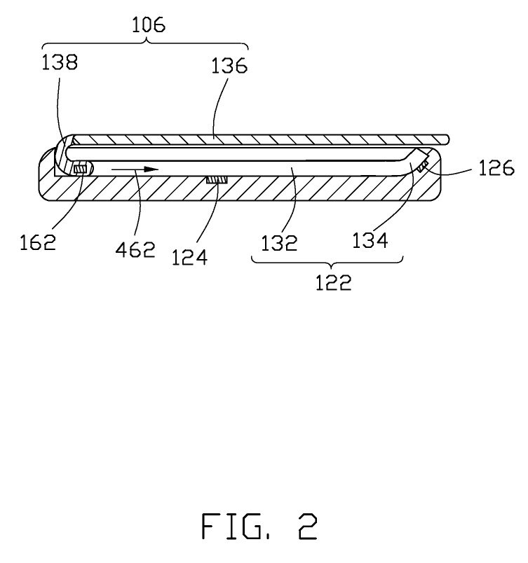

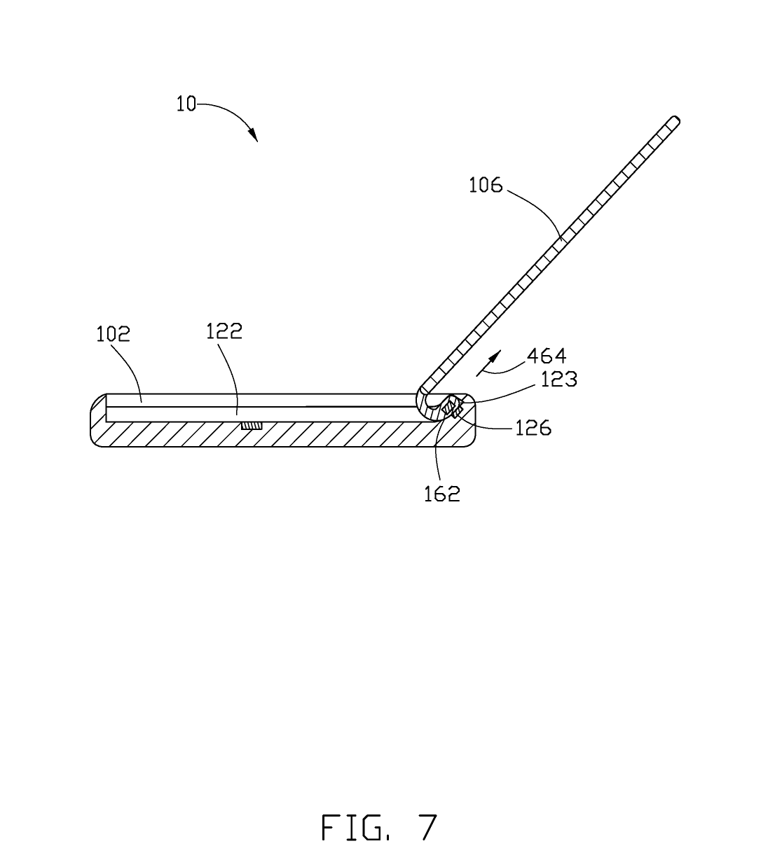

The second housing 104 further includes a second housing magnetic member 162 that is disposed in the bent portion 138 of the sliding member 106. The second housing magnetic member 162 and the first magnetic member 124 produce a first magnetic attraction force 462 (see FIG. 2) for facilitating the second housing 104 to move to the second position. The second housing magnetic member 162 and the second magnetic member 126 produce a second magnetic attraction force 464 (see FIG. 7) for facilitating the second housing 104 to move from the second position to the third position. The first magnetic attraction force 462 and the second magnetic attraction force 464 are exerted in a first direction and a second direction that are different from each other for facilitating the parallel sliding movement and the pivotable movement of the second housing 104 relative to the first housing 102 respectively.

Hereinafter, an operation of the first communication device 10 will be described.

In operation, the first communication device 10 may be initially positioned in the first position. In the first position, the second housing 104 substantially covers the top surface of the first housing 102 as shown in FIG.1. When a given force is applied to the second housing 104 along a direction parallel to the bottom surface of the second housing 104, the second housing 104 slides with respect to the first housing 102, and one or more keys 128 of the first housing 102 become exposed.

Under this given force, the movement of the second housing 104 is guided by the bent portions 138 sliding in the straight grooves 132, such that the second housing 104 keeps sliding relative to the first housing 102. As the first magnetic member 124 and the second housing magnetic member 162 moves toward each other, a progressively increasing first magnetic attraction force 462 is produced between them. As such, the second housing 104 continues to slide with respect to the first housing 102. When the first magnetic member 124 and the second housing magnetic member 162 are adjacent to each other, the first magnetic attractive force 462 is the strongest and this inhibits further movement of the second housing 104 relative to the first housing 102. In this condition, the second housing 104 is in the second position. In the second position, the second housing 104 partially covers the first housing 102, where some of the plurality of keys 128, such as numeric keys of the first housing 102 are exposed.

When the second housing 104 is in the second position, a force to overcome the first attraction force between the second housing magnet member 162 and the first magnet member 124 can be applied to move the second housing 104 to the third position. The bent portion 138 are slidably guided in the straight grooves 132 away from the first magnetic member 124, and moves to the second magnetic member 126. When the second housing 104 moves from the second position to the third position, the first magnetic attraction force 462 (see FIG. 2) progressively decreases, and the second magnetic attraction force 464 (see FIG. 7) between the second housing magnetic member 162 and the second magnet member 126 progressively increases, thus, the bent portions 138 are actuated to move quickly, and slides in the curved grooves 134. The curved grooves 134 make the second housing 104 pivot relative to the first housing 102. Furthermore, the second magnetic attraction force 464 holds the second housing 104 in position in the third position. In the third position, substantially all the keys 128 are exposed on the top surface of the first housing 102. The first housing 102 may be lie flat on a table, and the second housing 104 tilted relative to the first housing 102 and the table, so that the first communication device 10 may be conveniently operated to play video games, display movies and as a television in the third position.

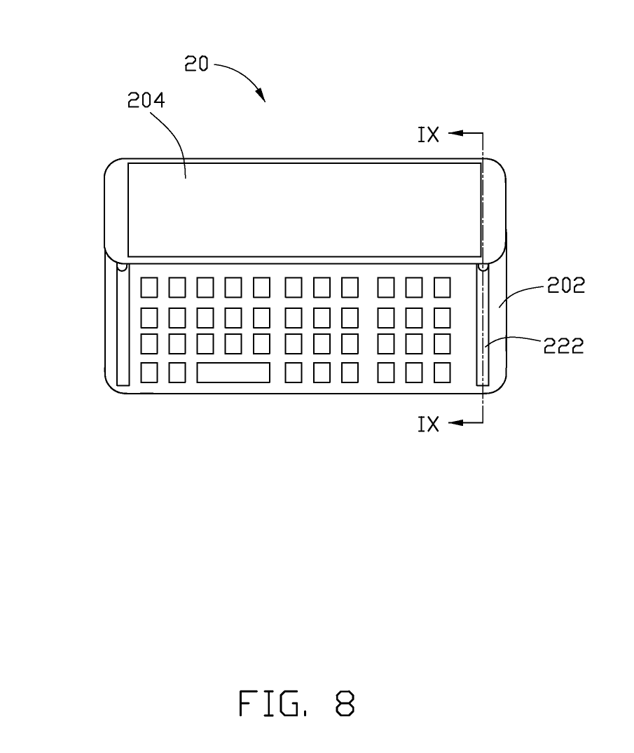

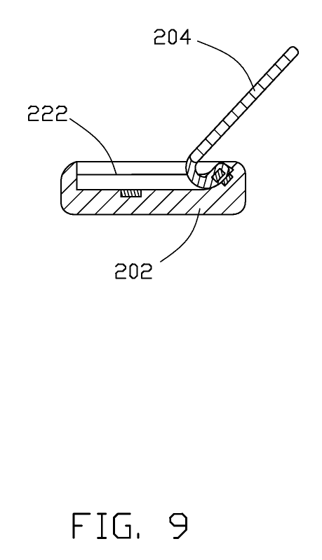

Referring to FIGS. 8-9, a second communication device 20 such as a mobile phone in a third position in accordance with a second exemplary embodiment is illustrated. The second communication device 20 includes a first housing 202 and a second housing 204. The first housing 202 and the second housing 204 are configured to have substantially the same lengths and widths. The second housing 102 is configured to be moveable relative to the second housing 204, the movement is sequentially from a first position, to a second position, and to a third position.

A main difference between the second communication device 20 and the first communication device 10 is that a pair of guiding grooves 222 is defined in two relatively shorter sides of the top surface of the first housing 202. The second communication device 20 has similar configurations of sliding members and magnetic members associated thereof with the first communication device 10.

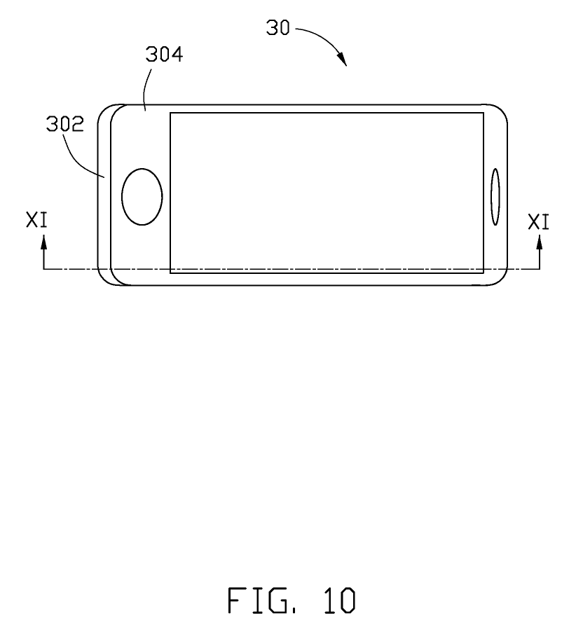

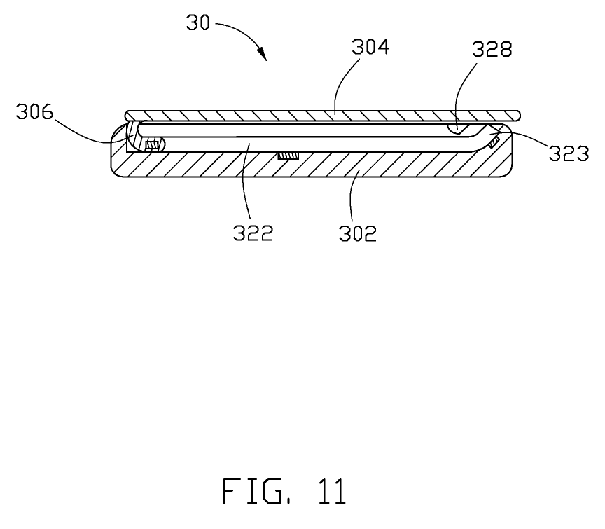

Referring to FIGS. 10-11, a third communication device 30 such as a mobile phone in accordance with a third exemplary embodiment is illustrated. The third communication device 30 includes a first housing 302 and a second housing 304. The first housing 302 and the second housing 304 are configured to have substantially the same lengths and widths. The second housing 302 is configured to moveable relative to the second housing 304 sequentially from a first position, to a second position, and further to a third position. The third communication device 30 is configured with sliding members and a plurality of magnetic members similar to the first communication device 10.

The first housing 302 further defines a retaining recess 328 in a top surface of the first housing 302. The retaining recess 328 is located adjacent to a curved groove 323 for supporting the second housing 304 on the first housing 302 when the third communication device 30 is in the third position. More specifically, the retaining recess 328 receives an end of a planar plate 136 of the second housing 304 after a pivotable movement of the second housing 304 relative to the first housing 302 is completed.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A communication device, comprising:
a first housing provided with a plurality of keys for inputting commands to the communication device, the first housing defining at least one guiding groove in a top surface of the first housing; and
a second housing slidably and pivotably coupled to the first housing, the second housing provided with at least one sliding member corresponding to the at least one guiding groove, the at least one sliding member capable of being slidably fitted in the at least one guiding groove for guiding the second housing to slide relative to the first housing sequentially from a first position, to a second position, and a third position, where the second housing substantially covering all the plurality of keys disposed on the top surface of the first housing in the first position, the second housing partially covering the plurality of keys in the second position, and the second housing inclined at an angle with respect to the first housing and substantially all the plurality of keys exposed to be viewable on the top surface of the first housing in the third position.

2. The communication device of claim 1, wherein the at least one guide grove is formed by a straight groove and a curved groove, the sliding member engageably fitted in the straight groove for providing substantially parallel sliding movement of the second housing relative to the first housing, and the sliding member engageably fitted in the curved groove for providing a pivotable movement of the second housing relative to the first housing.

3. The communication device of claim 2, wherein the guiding member comprises:
a planar plate mounted to the second housing, and
a bent portion formed at an end of the planar plate, the bent portion sliably received in the guiding groove defined in the first housing.

4. The communication device of claim 3, further comprising:
a first magnetic member disposed in the straight groove; and
a second magnetic member disposed in the bent portion of the guiding member, the second magnetic member and the first magnetic member producing a first magnetic attraction force for facilitating the second housing to move relative to the first housing from the first position to the second position.

5. The communication device of claim 4, further comprising:
a second housing magnetic member disposed in the curved groove; the second magnetic member and the second housing magnetic member producing a second magnetic attraction force for facilitating the second housing to move relative to the first housing from the second position to the third position.

6. The communication device of claim 1, wherein the first housing further defines a retaining recess for supporting the second housing after a pivotable movement of the second housing relative to the first housing is completed.

7. A communication device for providing a multi-position opening mechanism, comprising:
a first housing defining a pair of guiding grooves on a top surface of the first housing, the guiding groove formed by a straight groove extending substantially parallel to the top surface of the first housing, and a curved groove communicating with the straight groove and extending slantwise with respect to the top surface of the first housing; and
a second housing provided with a pair of sliding members disposed at a bottom surface of the second housing corresponding to the pair of guiding grooves, the pair of sliding members capable of sliding in the straight groove for providing a parallel movement of the second housing with respect to the first housing, the pair of sliding members capable of sliding in the curved groove for proving a pivotable movement of the second housing with respect to the first housing.

8. The communication device of claim 7, wherein each of the sliding members comprises:
a planar plate mounted to the second housing, and
a bent portion formed at an end of the planar plate the bent portion capable of being sliably received in the guiding groove defined in the first housing.

9. The communication device of claim 8, further comprising:
a first magnetic member disposed in the straight groove; and
a second magnetic member disposed in the bent portion of the guiding member, the second magnetic member and the first magnetic member producing a first magnetic attraction force for facilitating the second housing to move slidably relative to the first housing.

10. The communication device of claim 9, further comprising:
a second housing magnetic member disposed in the curved groove; the second magnetic member producing a second magnetic attraction force with the second housing magnetic member for facilitating the second housing to move pivotably relative to the first housing.

11. The communication device of claim 10, wherein the first housing further defines a retaining recess for supporting the second housing after a pivotable movement of the second housing relative to the first housing is completed.

12. A communication device, comprising:
a first housing disposed with a first magnetic member and a second magnetic member, and defining at least one guiding groove therein; and
a second housing disposed with a second housing magnetic member and at least one sliding member, the second housing slidably and pivotably coupled to the first housing by associating the at least one sliding member with the at least one guiding groove, the second housing magnetic member and the first magnetic member producing a first magnetic attraction force in a first direction for guiding the second housing to move substantially parallel to the first housing, the second housing magnetic member and the second magnetic member producing a second magnetic attraction force in a second direction different form the first direction of the first magnetic attraction force for guiding the second housing to pivot relative to the first housing.

13. The communication device of claim 12, wherein the first housing further defines a retaining recess for supporting the second housing after a pivotable movement of the second housing relative to the first housing is completed.

14. The communication device of claim 12, wherein the at least one guiding groove is defined in the top surface of the first housing, the guiding groove is formed with a straight groove extending substantially parallel to the top surface of the first housing, and a curved groove communicating with straight groove and extending slantwise with respect to the top surface of the first housing.

15. The communication device of claim 14, wherein the at least one sliding member is disposed at a bottom surface of the second housing corresponding to the at least one guiding groove, the at least one sliding member is capable of sliding in the straight groove for providing a parallel movement of the second housing with respect to the first housing, the sliding member is capable of sliding in the curved groove for proving a pivotable movement of the second housing with respect to the first housing.

16. The communication device of claim 15, each of the sliding members comprises:
a planar plate mounted to the second housing; and
a bent portion formed at an end of the first portion, the bent portion sliably received in the guiding groove defined in the first housing.

17. The communication device of claim 16, wherein the first housing further defines a retaining recess, one end of the planar plate is received in the retaining recess, where the second housing is pivoted relative to the second housing.
